(19) United States
(12) Patent Application Publication
(10) Pub. No.: US 2019/0052489 A1
(43) Pub. Date: Feb. 14, 2019

(54) COMMUNICATION INTERFACE AND INTERFACING METHOD THEREOF

(71) Applicant: Powertech Technology Inc., Hsinchu County (TW)

(72) Inventors: Chih-Hui Yeh, Hsinchu County (TW); Ping-Che Lee, Hsinchu County (TW); Fu-Hsiang Chang, Hsinchu County (TW)

(73) Assignee: Powertech Technology Inc., Hsinchu County (TW)

(21) Appl. No.: 15/672,289

(22) Filed: Aug. 8, 2017

(51) Int. Cl. H04L 25/49; H04L 7/00; H04L 7/033; G08C 19/28

(52) U.S. Cl. CPC H04L 25/4917; H04L 7/0012; H04L 25/49; G08C 19/28; H04L 7/0337

(57) ABSTRACT

The communication interface including a data encoder. The data encoder receives a data package which has at least one first output signal with N bits, generates and outputs at least one transmitting signal during one period of a reference clock signal and determining a voltage level of the transmitting signal according to a logic value of the first output signal, wherein N is an integer larger than 1.

### BACKGROUND

### Field of the Invention

The invention relates to a communication interface and communication interfacing method thereof. Particularly, the invention relates to the communication interface and communication interfacing method thereof for improving communication rate.

### Description of Related Art

In recently years, electronic device is widely used in human's life. For performing better service, large mount data transmitted between electronic devices is necessary in currently usage. For transmitting a digital data, one bit data can be transmitted by one period of a reference clock. That is, when a plurality of bits of data need to be transmitted, a long transmitting time with a plurality of clock periods is needed. Time cost is increased accordingly.

### SUMMARY OF THE INVENTION

The invention is directed to a communication interface for improving communication rate.

The invention provides a communication interface including a data encoder. The data encoder receives a data package which has at least one first output signal with N bits, generates and outputs a transmitting signal during a period of a reference clock signal and determines a voltage level of the transmitting signal according to a logic value of the first output signal, wherein N is an integer larger than 1.

The invention also provides a communication interfacing method. The communication interfacing method includes: receiving data package which has at least one first output signal with N bits; generating and outputting a transmitting signal during a period of a reference clock signal, and determining a voltage level of the transmitting signal according to a logic value of the first output signal, wherein N is an integer larger than 1.

According to the above descriptions, the present disclosure provides the data encoder to encode the first output signal with a plurality of bits to a transmitting signal, and output the transmitting signal during one period of a reference clock signal, where the transmitting signal is a multi-level voltages signal. That is, the first output signal with two or more bits can be transported to a receiving device during one period of the reference clock, and the communication rate can be improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic plot of a communication interface according to an embodiment of present disclosure.

FIG. 2A illustrates a schematic diagram of a relationship between a voltage level of the transmitting signal and a digital value of the output signal according an embodiment of present disclosure.

FIG. 2B illustrates a waveform plot of the transmitting signal according to an embodiment of present disclosure.

FIG. 3A and FIG. 3B illustrate schematic plots of the data encoders according to different embodiments of present disclosure.

FIG. 4 illustrates a schematic diagram of the data encoder for encoding a 2 bits output signal to a 4-levels transmitting signal according to an embodiment of present disclosure.

FIG. 5A illustrates a schematic diagram of a receiving device receiver and an interface thereof according to an embodiment of present disclosure.

FIG. 5B illustrates a schematic diagram of the transmitting signal voltage decoder according to an embodiment of present disclosure.

FIG. 6A to FIG. 6C illustrate waveform plots of the communication interface according to different embodiments of present disclosure.

FIG. 7 illustrates a flow diagram of a communication interfacing method according to an embodiment of present disclosure.

### DETAILED DESCRIPTION OF DISCLOSED EMBODIMENTS

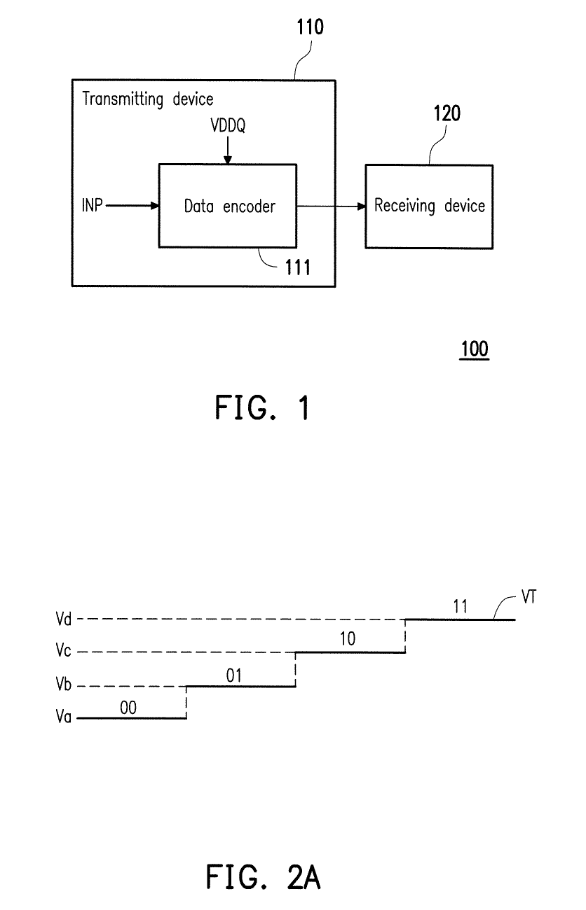

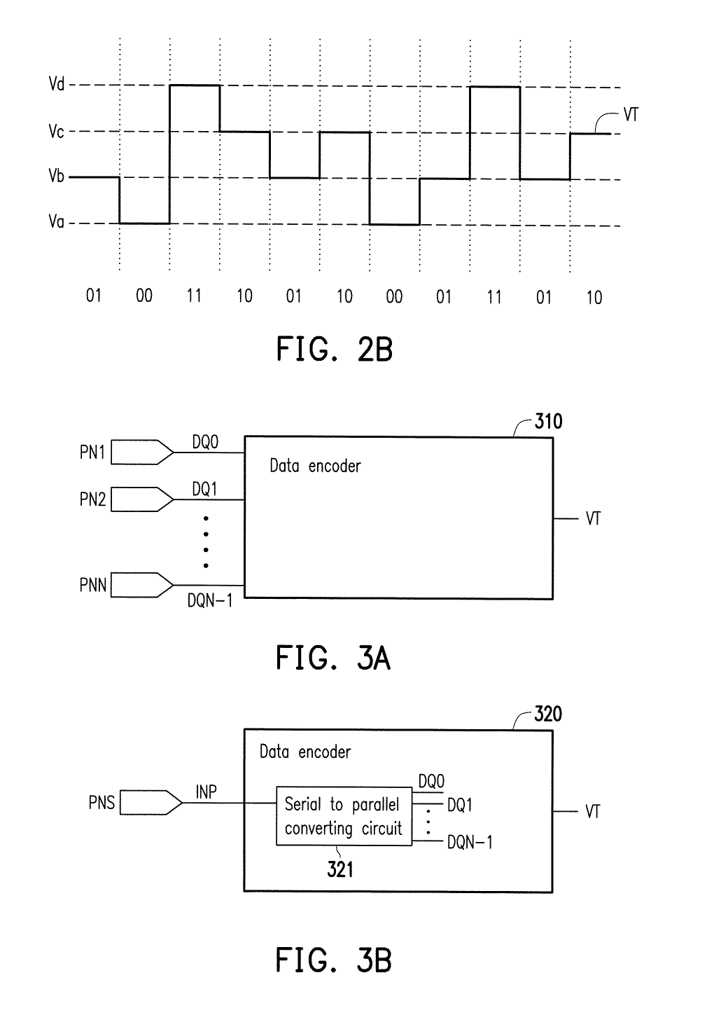

Referring to FIG. 1, which illustrates a schematic plot of a communication interface according to an embodiment of present disclosure. The communication interface 100 includes a transmitting device 110 and a receiving device 120. The transmitting device 110 and the receiving device 120 may be two electronic devices. The transmitting device 110 includes a data encoder 111. The data encoder 111 receives a data package, and the data package has an output signal INP with N bits, where N is an integer larger than 1. The data encoder 111 is coupled to the receiving device 120 and provides a transmitting signal VT to the receiving device 120 according to the output signal INP. In detail operation, the data encoder 111 may receive the output signal INP with 2 or more bits and generate the transmitting signal VT. The data encoder 111 determines a voltage level of the transmitting signal VT according to a digital value of the output signal INP. Herein, referring to FIG. 2A which illustrates a schematic diagram of a relationship between a voltage level of the transmitting signal and a digital value of the output signal according an embodiment of present disclosure. For example, in FIG. 2A, the output signal INP is a two bits digital signal. Corresponding to a two bits output signal (with digital value 00, 01, 10 or 11), four different levels Va, Vb, Vc, or Vd can be generated as the transmitting signal VT. Herein, the voltage level of the transmitting signal VT may be the level Va for transporting the digital value “0 0”; the voltage level of the transmitting signal VT may be the level Vb for transporting the digital value “0 1”; the voltage level of the transmitting signal VT may be the level Vc for transporting the digital value “1 0”; or the voltage level of the transmitting signal VT may be the level Vd for transporting the digital value “1 1”. The voltage level on the transmitting signal is decided based on the digital values of the output signal INP is “0 0”, “0 1”, “1 0” or “1 1”.

The voltage level of the transmitting signal VT is kept unchanged during one period of a reference clock signal.

In FIG. 2A, the output signal INP with two bits can be transported to the receiving device 120 through the transmitting signal VT, a communication rate of the communication interface 100 is improved.

In a data communication flow, the data encoder 111 may receive a data package, and divide the data package to a plurality of divided signals. Then, the data encoder 111 may receive each of the divided signals to be the output signal in sequence, and generate a plurality of transmitting signals respectively corresponding to a plurality periods of the reference clock signal. For example, if the data package has 24 logic bits, only 12 periods are necessary to transport the data package to the receiving device 120 by reference to the embodiment in FIG. 2A.

The output signal INP in FIG. 2A with two bits is only an exemplary example and not to limit a scope of present disclosure. The bit number of the output signal INP may be N (larger than 1). In this case, the output signal INP may have 2^{N} possible digital values. And, the data encoder 111 can generate the transmitting signal VT with 2^{N} possible voltage levels respectively corresponding to the 2^{N} possible digital values.

Furthermore, in FIG. 2A, the voltage level of the transmitting signal VT is direct proportion to the digital value of the output signal INP. In some embodiment, the voltage level of the transmitting signal VT may be inverse proportion to the digital value of the output signal INP.

In some embodiment, the transmitting device 110 may be a tester, and the receiving device 120 may be a device under test. The data package may be test command or test pattern, and can be transmitted to the receiving device 120 rapidly for a testing operation.

Referring to FIG. 2B, which illustrates a waveform plot of the transmitting signal according to an exemplary embodiment of present disclosure. In FIG. 2B, a plurality digital values of the output signal are decoded to generate the transmitting signal VT. The digital values are respectively “0 1”, “0 0”, “1 1”, “1 0”, “0 1”, “1 0”, “0 0”, “0 1”, “1 1”, “0 1” and “1 0” in sequence. By referring to the relation in FIG. 2A, the transmitting signal VT can be a multi-levels signal, and voltage levels of the transmitting signal VT can be the levels Vb, Va, Vd, Vc, Vb, Vc, Va, Vb, Vd, Vb and Vc. In this way, a plurality of bits of the output signal can be transported rapidly.

Referring to FIG. 3A and FIG. 3B, which illustrate schematic diagram of the data encoders according to different embodiments of present disclosure. In FIG. 3A, the data encoder 310 is coupled to a plurality of pins PN1-PNN, and receives N bits DQ0-DQN-1 of an output signal. The data encoder 310 may encode the N bits DQ0-DQN-1 of the output signal to generate a transmitting signal VT, where a voltage level of the transmitting signal VT is determined by the digital value of the N bits DQ0-DQN-1, and the transmitting signal VT is transported out during one clock period by the data encoder 310.

In FIG. 3B, the data encoder 320 further include a serial to parallel converting circuit 321. The serial to parallel converting circuit 321 may be coupled to a single pin PNS to receive the output signal INP in serial format. The serial to parallel converting circuit 321 may convert the output signal INP in serial format to the N bits DQ0-DQN-1 of the output signal INP in parallel format. Afterward, the data encoder 320 may generate the transmitting signal VT according to digital value of the N bits DQ0-DQN-1 of the output signal INP.

The serial to parallel converting circuit 321 can be implemented by any serial to parallel converting circuit, and no special limitation is set forth herein.

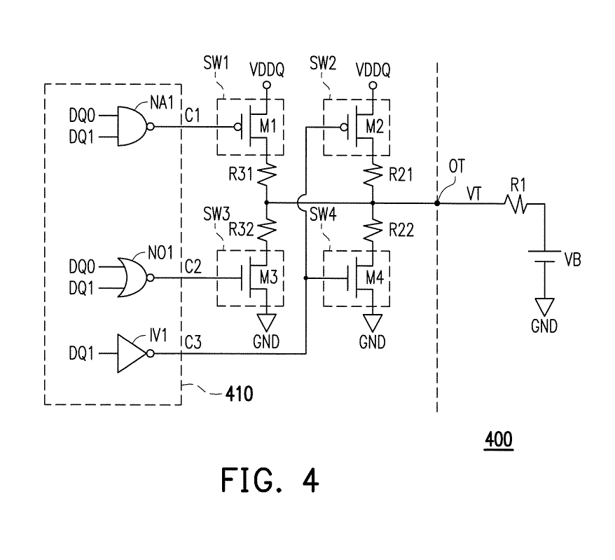

Referring to FIG. 4, which illustrates a schematic diagram of the data encoder according to an embodiment of present disclosure. The data encoder 400 includes switches SW1-SW4, resistors R21, R22, R31 and R32 and a logic circuit 410. The data encoder 400 has an output end OT for providing a transmitting signal VT. The output end OT is coupled to a load with a resistor R1 and a bias voltage VB. The resistor R31 has a first end coupled to the output end OT, and a second end coupled to the switch SW1. The switch SW1 is coupled between the power voltage VDDQ and the resistor R31, and controlled by a control signal C1. The resistor R21 has a first end coupled to the output end OT, and a second end coupled to the switch SW2. The switch SW2 is coupled between the power voltage VDDQ and the resistor R21, and controlled by a control signal C3. The resistor R32 has a first end coupled to the output end OT, and a second end coupled to the switch SW3. The switch SW3 is coupled between a reference ground GND and the resistor R32, and controlled by a control signal C2. The resistor R22 has a first end coupled to the output end OT, and a second end coupled to the switch SW4. The switch SW4 is coupled between the reference ground GND and the resistor R22, and controlled by a control signal C3.

In FIG. 4, the switches SW1-SW4 are respectively formed by transistors M1-M4. The transistors M1 and M2 are P-type transistors, and the transistors M3 and M4 are N-type transistors. All of the transistors M1-M4 may be Metal-Oxide-Semiconductor Field-Effect Transistor (MOSFET).

The control signals C1-C3 are generated by the logic circuit 410. In present embodiment, the logic circuit 410 includes a NAND gate NA1, a NOR gate NO1 and a NOT gate IV1. The NAND gate NA1 receives two bits DQ0 and DQ1 of an output signal, and operation NAND logic operation on the two bits DQ0 and DQ1 to generate the control signal C1. The NOR gate also receives the two bits DQ0 and DQ1 of the output signal, and operation NOR logic operation on the two bits DQ0 and DQ1 to generate the control signal C2. The NOT gate IV1 generates the control signal C3 by inverting the bit DQ1 of the output signal.

For example, in FIG. 4, resistances of the resistors R31, R21, R32, and R22 may be respectively 16.6 Ohm, 50 Ohm, 16.6 Ohm and 50 Ohm, a resistance of the resistor R1 may be 12.5 Ohm, a voltage level of the bias voltage VB may be 0.6V and a voltage level of the power voltage VDDQ may be 1.2V. If a digital value of the two bits DQ0 and DQ1 of the output signal is “0 0”, the switches SW3 and SW4 are turned on and the switches SW1 and SW2 are cut-off. The data encoder 400 can generate the transmitting signal VT with a voltage level equal to (0.6×(R32//R22))/((R32//R22)+R1)=0.3V. If the digital value of the two bits DQ0 and DQ1 of the output signal is “1 0”, the switch SW4 is turned on and the switches SW1-SW3 are cut-off. The data encoder 400 can generate the transmitting signal VT with the voltage level equal to 0.6×R22/(R22+R1)=0.48V. If the digital value of the two bits DQ0 and DQ1 of the output signal is “0 1”, the switch SW2 is turned on and the switches SW1, SW3-SW4 are cut-off. The data encoder 400 can generate the transmitting signal VT with the voltage level equal to 1.2×R1/(R21+R1)+0.6×R21/(R21+R1)=0.72V. If the digital value of the two bits DQ0 and DQ1 of the output signal is “1 1”, the switches SW1-SW2 are turned on and the switches SW3-SW4 are cut-off. The data encoder 400 can generate the transmitting signal VT with the voltage level equal to 1.2×R1/((R31//R21)+R1)+0.6×(R31//R21)/((R31//R21)+R1)=0.9V. Wherein, the operator “//” is used to calculate a resistance of two resistors connected in parallel.

The logic gates in the logic circuit 410 can be replaced by other logic gate with same logic function. For example, the NAND gate NA1 can be replaced by a AND gate and a NOT gate coupled in series, or the NAND gate NA1 can be replaced by two NOT gate for receiving the two bits DQ0 and DQ1 of the output signal and an OR gate for receiving outputs of the two NOT gates.

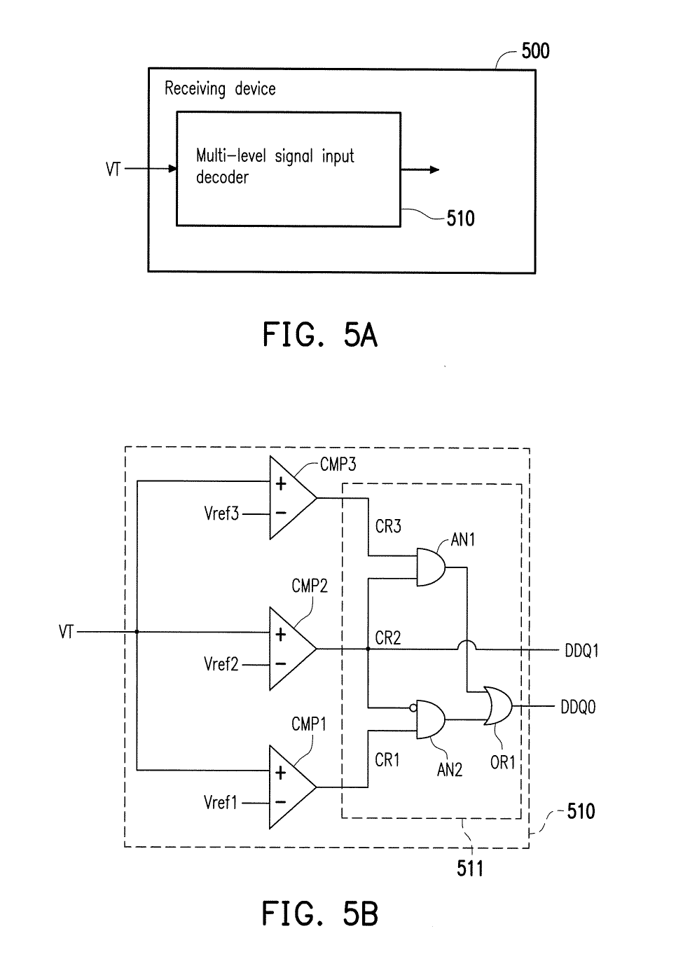

FIG. 5A illustrates a schematic diagram of a receiving device according to an embodiment of present disclosure. The receiving device 500 includes a multi-level signal input decoder 510. The multi-level signal input decoder 510 may be coupled to a transmitting device for receiving a transmitting signal VT. The multi-level signal input decoder 510 may receive and decode the transmitting signal VT to obtain the bits of the output signal. In detail, the multi-level signal input decoder 510 may compare the transmitting signal VT with a plurality of threshold voltages to obtain the bits of the output signal. For example, there may be three threshold voltages Vref1, Vref2 and Vref3 set in the multi-level signal input decoder 510, where Vref1<Vref2<Vref3. The transmitting signal VT is compared with all of the threshold voltages Vref1, Vref2 and Vref3. When the transmitting signal VT is smaller than the threshold voltage Vref1, the two bits of the output signal may be “0 0”. When the transmitting signal VT is between the threshold voltage Vref1 and the threshold voltage Vref2, the two bits of the output signal may be “0 1”. When the transmitting signal VT is between the threshold voltage Vref2 and the threshold voltage Vref3, the two bits of the output signal may be “1 0”. When the transmitting signal VT is larger than the threshold voltage Vref3, the two bits of the output signal may be “1 1”.

The output signal with two (or more) bits can be recovered and obtained during one period of the reference clock by the multi-level signal input decoder 510. A data package having a plurality of output signals can be recovered and obtained by the multi-level signal input decoder 510 during a plurality of periods of the reference clock signal.

Voltage levels of the threshold voltages Vref1-Vref3 can be set according to possible voltage levels of the transmitting signal VT. For example, if the possible voltage levels of the transmitting signal VT are 0.3V, 0.48V, 0.72V and 0.90V, the voltage levels of the threshold voltages Vref1-Vref3 can be respectively set to 0.39V, 0.60V and 0.81V. Where the voltage level of the threshold voltage Vref1 can be set by averaging two lower voltage levels (0.3V and 0.48V) of the possible voltage levels; the voltage level of the threshold voltage Vref1 can be set by averaging two middle voltage levels (0.48V and 0.72V) of the possible voltage levels; and the voltage level of the threshold voltage Vref3 can be set by averaging two upper voltage levels (0.72V and 0.90V) of the possible voltage levels.

FIG. 5B illustrates a schematic diagram of the multi-level signal input decoder according to an embodiment of present disclosure. The multi-level signal input decoder 510 includes a plurality of comparators CMP1-CMP3 and a logic circuit 511. The comparators CMP1-CMP3 commonly receives the transmitting signal VT and respectively receive the threshold voltages Vref1-Vref3. The comparators CMP1-CMP3 respectively compare the threshold voltages Vref1-Vref3 with the transmitting signal VT to generate comparison results CR1-CR3, respectively. The logic circuit 511 includes two AND gates AN1 and AN2 and an OR gate OR1. The AND gate AN1 operates a logic AND operation on the comparison results CR3 and CR2. The AND gate AN2 operates another logic AND operation on the comparison results CR1 and an inverted signal of the comparison result CR2. The OR gate OR1 operates a logic OR operation on outputs of the AND gates AN1 and AN2 to generate a bit DDQ0 of a decoded result signal. The comparison result CR2 may be set to another bit DDQ1 of the decoded result signal.

In detail, if the voltage level of the transmitting signal VT is smaller than the smallest threshold voltage Vref1, all of the comparison results CR1-CR3 are logic “0”, and the bits DDQ0 and DDQ1 of the decoded result signal are “0 0”. If the voltage level of the transmitting signal VT is larger than the smallest threshold voltage Vref1 and smaller than the middle threshold voltage Vref2, the comparison result CR1 is logic “1” and the comparison results CR2-CR3 are logic “0”, and the bits DDQ0 and DDQ1 of the decoded result signal are “1 0”. If the voltage level of the transmitting signal VT is larger than the middle threshold voltage Vref2 and smaller than the largest threshold voltage Vref3, the comparison results CR1-CR2 are logic “1” and the comparison result CR3 is logic “0”, and the bits DDQ0 and DDQ1 of the decoded result signal are “0 1”. If the voltage level of the transmitting signal VT is larger than the largest threshold voltage Vref2, all of the comparison results CR1-CR3 are logic “1”, and the bits DDQ0 and DDQ1 of the decoded result signal are “1 1”.

That is, the output signal in the transmitting device can be recovered in the receiving device 500 by decoding one transmitting signal VT during one period of the reference clock. Also, a data package can be obtained in the receiving device 500 by decoding a plurality of levels on the transmitting signal VT after a plurality of periods of the reference clock.

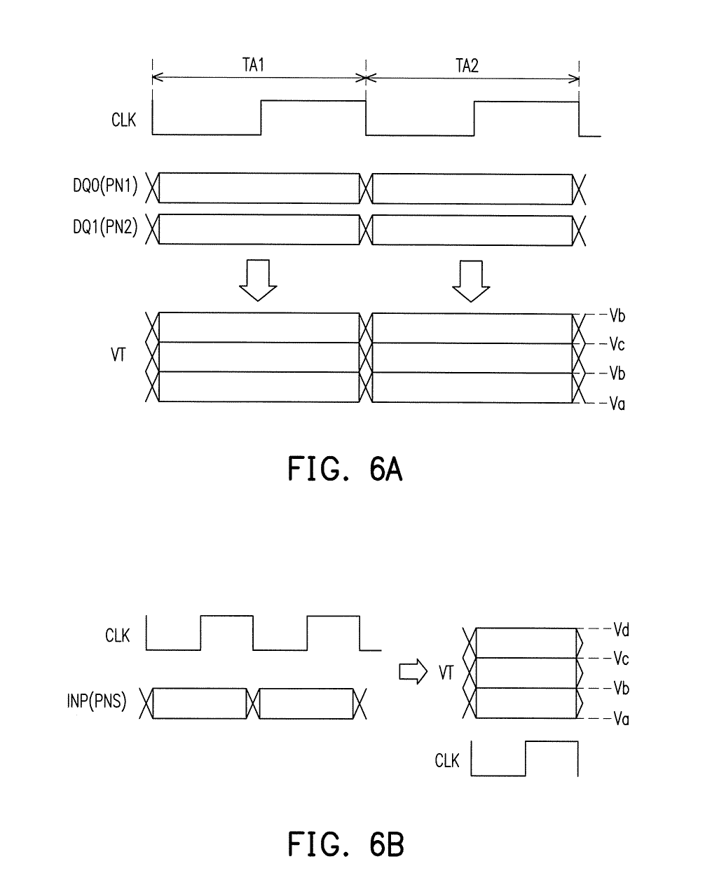

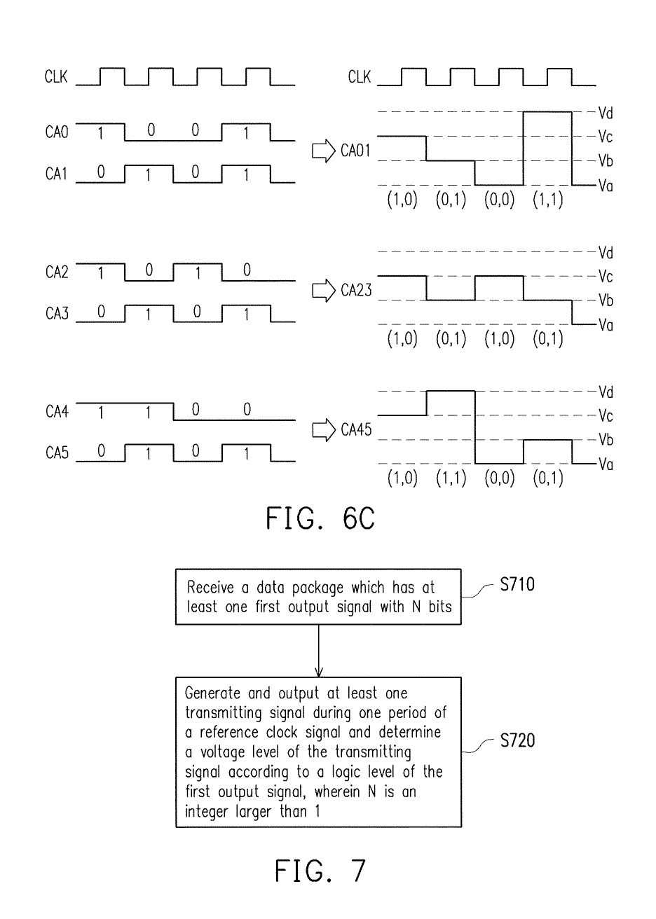

FIG. 6A to FIG. 6C illustrate waveform plots of the communication interface according to different embodiments of present disclosure. In FIG. 6A, the data encoder may receive two bits DQ0 and DQ1 of an output signal through two different pins PN1 and PN2, respectively. During each of two clock periods TA1 and TA2 based on a reference clock signal CLK, two bits DQ0 and DQ1 can be received by the data encoder, and the transmitting signal VT can be generated and outputted by one output pin according to the digital value of the two bits DQ0 and DQ1 of the output signal. That is, number of pins can be saved for outputting the transmitting signal VT in the communication interface of present disclosure.

In FIG. 6B, the data encoder may receive the output signal INP through one pin PNS in serial format based on the reference clock signal CLK. Herein, two bits of the output signal INP can be received by the data encoder during two clock periods of the reference clock signal CLK. The data encoder may encode the two received bits to generate the transmitting signal VT according to the digital value of the two received bits, and output the transmitting signal VT during one period of the reference clock signal CLK. That is, time for transmitting the transmitting signal VT can be saved.

It should be noted here, in the embodiments of FIG. 6A and FIG. 6B, the output signal INP has two bits DQ0 and DQ1, and the voltage level of the transmitting signal VT may be one of voltage levels Va, Vb, Vc and Vb according to 4 possible digital values of the bits DQ0 and DQ1.

In FIG. 6C, the data encoder may have a plurality receiving channels for receiving a plurality of output signals. The output signals may be divided from a same data package. For example, the data encoder is coupled to pins CA0-CA1 to receive two bits of a first output signal of the data package; coupled to pins CA2-CA3 to receive two bits of a second output signal of the data package; and coupled to pins CA4 and CA5 to receive two bits of a third output signal of the data package. Digital values of the bits on the pins CA0-CA5 may be varied or kept unchanged based on each period of the reference clock signal CLK. The data encoder may receive the two bits of the first output signal with logic “1 0”, “0 1”, “0 0” and “1 1” through pins CA0 and CA1 in sequence, and generate and output the transmitting signal by a first pin CA01 with voltage level Vc, Vb, Va and Vd in sequence. The data encoder may receive the two bits of the first output signal with logic “1 0”, “0 1”, “1 0” and “0 1” through pins CA2 and CA3 in sequence, and generate and output the transmitting signal by a second pin CA23 with voltage level Vc, Vb, Vc and Vb in sequence. The data encoder may also receive the two bits of the first output signal with logic “1 0”, “1 1”, “0 0” and “0 1” in sequence through pins CA4 and CA5, and generate and output the transmitting signal by a third pin CA45 with voltage level Vc, Vd, Va and Vb in sequence.

That is, pin numbers for transmitting three output signals with 6 bits can be minimized to 3 pins CA01, CA23 and CA45 by the data encoder.

FIG. 7 illustrates a flow diagram of a communication interfacing method according to an embodiment of present disclosure. A step S710 is executed for receiving a data package which has at least one first output signal with N bits, where N is an integer larger than 1. Then, a step S720 is executed for generating and outputting at least one transmitting signal during one period of a reference clock signal, and determining a voltage level of the transmitting signal according to a logic value of the first output signal.

Detail operations of the steps S710 and S720 can be referred to the embodiments mentioned above, and no more repeated description here.

In summary, the present disclosure provides the data encoder for encoding the output signal with a plurality of bits into a transmitting signal, and transporting the transmitting signal to the receiving device during one period of the reference clock signal. That is, a plurality of bit can be transported to the receiving device in one clock period, and communication rate of the communication interface can be improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A communication interface, comprising:
a data encoder, receiving a data package which has at least one first output signal with N bits, generating and outputting at least one transmitting signal during one period of a reference clock signal and determining a voltage level of the transmitting signal according to a logic value of the first output signal, wherein N is an integer larger than 1.

2. The communication interface as claimed in claim 1, wherein the voltage level of the transmitting signal is kept unchanged during the period of the reference clock signal.

3. The communication interface as claimed in claim 1, wherein the data encoder further being configured to:
divide the data package into a plurality of divided signals; and
select one of the divided signals to be the first output signal,
wherein, each of the divided signals has N bits.

4. The communication interface as claimed in claim 1, wherein the data encoder receives the data package through one data pin with a serial interface.

5. The communication interface as claimed in claim 4, wherein the data encoder further comprises:
a serial to parallel converting circuit, converting the data package with serial format to a parallel format data package.

6. The communication interface as claimed in claim 1, wherein the data encoder receives the data package through a plurality of data pins.

7. The communication interface as claimed in claim 2, wherein the data encoder further selects another one of the divided signals to be a second output signal, and generates the transmitting signal according to the second output signal.

8. The communication interface as claimed in claim 1, wherein the data encoder comprises:
a plurality of resistors, respectively having first ends coupled to an output end;
a plurality of switches, where first ends of the switches respectively coupled to second ends of the resistors, a second end of each of the switches is coupled to a reference ground or a power voltage, and the switches respectively controlled by a plurality of control signals to be turned-on or cut-off; and
a logic circuit, receiving the N bits of the first output signal and generating the control signals according to the N bits of the first output signal.

9. The communication interface as claimed in claim 8, wherein the resistors comprise:
a first resistor, having a first end coupled to the output end;
a second resistor, having a first end coupled to the output end;
a third resistor, having a first end coupled to the output end; and
a fourth resistor, having a first end coupled to the output end;
the switches comprise:
a first switch, having a first end coupled to the power voltage, a second end coupled to the second end of the first resistor, an controlled by a first control signal;
a second switch, having a first end coupled to the power voltage, a second end coupled to the second end of the second resistor, an controlled by a second control signal;
a third switch, having a first end coupled to the reference ground, a second end coupled to the second end of the third resistor, an controlled by a third control signal; and
a fourth switch, having a first end coupled to the reference ground, a second end coupled to the second end of the fourth resistor, an controlled by the second control signal.

10. The communication interface as claimed in claim 9, wherein the first switch and the second switch are respectively formed by a first P-type transistor and a second P-type transistor, and the third switch and the fourth switch are respectively formed by a first N-type transistor and a second N-type transistor.

11. The communication interface as claimed in claim 9, wherein the logic circuit comprises:
a NAND gate, receiving a first bit and a second bit of the first output signal, and generating the first control signal;
a NOR gate, receiving the first bit and the second bit of the first output signal and generating the third control signal; and
an inverter, receiving the second bit of the first output signal and generating the second control signal.

12. The communication interface as claimed in claim 8, wherein the output end is coupled to a load for receiving a load resister and a bias voltage.

13. The communication interface as claimed in claim 1, further comprising:
a receiving device, coupled to the data encoder for receiving the transmitting signal during the period of the reference clock signal.

14. The communication interface as claimed in claim 13, wherein the receiving device comprises:
a multi-level signal input decoder, receiving the transmitting signal and generating a decoded result signal with N bits by comparing the transmitting signal with a plurality of threshold voltages.

15. The communication interface as claimed in claim 14, wherein the multi-level signal input decoder comprises:
a plurality of comparators, respectively receiving the threshold voltages, commonly receive the transmitting signal, and generating a plurality of comparison results; and
a logic circuit, coupled to the comparators, receiving the comparison results and generating the decoded result signal.

16. A communication interfacing method, comprising:
receiving a data package which has at least one first output signal with N bits; and
generating and outputting at least one transmitting signal during one period of a reference clock signal and determining a voltage level of the transmitting signal according to a logic value of the first output signal, wherein N is an integer larger than 1.

17. The communication interfacing method as claimed in claim 16, further comprising:
dividing the data package into a plurality of divided signals; and
selecting one of the divided signals to be the first output signal,
wherein, each of the divided signals has N bits.

18. The communication interfacing method as claimed in claim 17, further comprising:
selecting another one of the divided signals to be a second output signal; and
generating the transmitting signal according to the second output signal during another one period of the reference clock.

19. The communication interfacing method as claimed in claim 16, further comprising:
providing a receiving device for receiving the transmitting signal during the period of the reference clock signal.

20. The communication interfacing method as claimed in claim 19, further comprising:
receiving the transmitting signal and generating a decoded result signal with N bits by comparing the transmitting signal with a plurality of threshold voltages by the receiving device.
